(19) United States
(12) Patent Application Publication
(10) Pub. No.: US 2005/0037324 A1
(43) Pub. Date: Feb. 17, 2005

(54) Data processing for fill-in-the-blanks question with a multiple-choice list

(76) Inventor: Haruyuki Sumimoto, Urawa-shi (JP)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/916,498

(22) Filed: Aug. 12, 2004

(30) Foreign Application Priority Data
Aug. 13, 2003 (JP) 2003-293012

(51) Int. Cl. G09B 7/00; G09B 19/00

(52) U.S. Cl. 434/322; 434/362; 434/118

(57) ABSTRACT

A process and apparatus for a computer-based testing system reads a file of question sentences, a corresponding choice file, and shared choice files and creates a multiple-choice list for a fill-in-the-blanks type of question. When creating the multiple-choice list, key words are searched in the corresponding choice file and the shared choice files. The shared choice files are referred to by any question sentence file.

### BACKGROUND OF THE INVENTION

1. Field of the Invention

The present invention relates to a system and a method of creating a computer-based testing system that shows ‘fill-in-the-blanks’ questions with a multiple-choice list for each blank, and lets the user select a correct choice.

2. Description of the Related Art

The following examples are known as learning or testing systems with which a user can learn knowledge.
(a) Gotaku
(b) Japan Patent Application Heisei 9-330011 ‘an electronic leaning machine’
(c) Japan Patent Application Heisei 4-268049 ‘an leaning support machine’
(d) Learning system using a link
(e) U.S. Pat. No. 6,632,096, Japan Patent 3554742
(f) Japan Patent 3321650 ‘an leaning system’

The advantage and demerit of these learning systems are explained below.

(a) Gotaku

Gotaku in Japanese language means ‘five choices’. It is a quiz program which is downloadable from a website on the Internet. The Gotaku system shows a short question sentence and corresponding five choices in a window. A user selects one choice and the system determines whether it is correct or not and shows the result.

The Gotaku system reads an enciphered hexadecimal file. Below is the example when the hexadecimal file is deciphered into a text file.

War Between the Genji and the Heike Clan

What is the battle in which the army of Yoshitune Minamotono and Noriyori Minamotono defeated the Heike army in 1184?

Battle in Ichinotani
Battle at Kurikara peak
Battle in Shijonawate
Battle in Yashima
Battle in Dannoura
   What is the battle in Sanuki area in which the army of Yoshitune Minamotono defeated the Heike army in 1185?
Battle in Yashima
Battle in Ishibashiyama
Battle at Kurikara peak
Battle in Ichinotani
Battle in Fujigawa

‘War between the Genji and the Heike clan’ in the first line is the title of this data file. The following lines comprise repetitions of ‘a blank line, a question sentence, a correct choice and four incorrect choices’.

A user will have difficulty in using this system to learn knowledge.

First, it is difficult to make data file. One must write short question sentences and corresponding answers. The sentences in a CD-ROM or a website on the Internet are often long and sometimes contain many key words in a single sentence. In such case, one must rewrite them into short question sentences and corresponding answers. It is cumbersome, time-consuming, and often difficult.

Second, one must create four corresponding incorrect choices for each correct answer. This is also cumbersome and time-consuming.

(b) Japan Patent Application Heisei 9-330011 ‘an Electronic Leaning Machine’

According to the disclosed method, an electronic dictionary can show a question and a corresponding multiple-choice list. A record of the dictionary includes an entry word, a part of speech, a pronunciation, meanings, example sentences and a question sentence with the entry word replaced to a blank.

The multiple-choice list comprises the corresponding entry word (this is the correct choice) and other entry words (these are incorrect choices). The system selects incorrect choices using information such as the part of speech and/or the address of the correct choice.

If the data includes more information such as classification, frequency of use, difficulty and so on, the system would be able to select more appropriate incorrect choices.

However, dictionary data format is strict. It comprises entry words and their attributes. One will have difficulty in converting an ordinary text file into dictionary data. It is difficult to use the system as learning or teaching tool because it is difficult to create and/or update the data.

Moreover, in a textbook, an explanatory book, or a collection book of problems, the contents is usually arranged by field. But, in a dictionary, the contents are arranged by word or in alphabetical order. One rarely learns a dictionary but uses it only when looking up a word.

(c) Japan Patent Application Heisei 4-268049 ‘a Leaning Support Machine’

According to the disclosed system, two kinds of data are used. One contains question sentences and another terms. The terms are the answers of its ‘fill-in-the-blanks’ questions.

Below is the example of the data.

@@question

Hideyoshi Toyotomi who succeeded Nobunaga Oda wiped out Hojo clan in Odawara in 1590 and ruled all over Japan at last.

@@terms

Nobunaga Oda,person
Hideyoshi Toyotomi,person
Shingen Takeda,person
Kenshin Ueshugi,person
1590,year
1594,year
1600,year
Odawara,place
Okehazama,place
Sekigahara,place

The system searches each term in the question sentence. In above case, the system will find Hideyoshi Toyotomi, Nobunaga Oda, Odawara and 1590. The system selects some of the terms at random and makes various questions like below.
(1) Hideyoshi Toyotomi who succeeded [ ] wiped out Hojo clan in Odawara in [ ] and ruled all over Japan at last.
(2) [ ] who succeeded Nobunaga Oda wiped out Hojo clan in Odawara in 1590 and ruled all over Japan at last.
(3) Hideyoshi Toyotomi who succeeded [ ] wiped out Hojo clan in [ ] in 1590 and ruled all over Japan at last.
(4) Hideyoshi Toyotomi who succeeded Nobunaga Oda wiped out Hojo clan in [ ] in [ ] and ruled all over Japan at last.

This system can be altered into a system that shows ‘fill-in-the-blanks’ questions and a multiple-choice list for each blank.

First, the system searches each term in the question sentence.

Second, it replaces the terms in the question sentences with blanks and shows the sentence. In above case, Hideyoshi Toyotomi, Nobunaga Oda, Odawara and 1590 will be replaced with blanks as below.
[ ] who succeeded [ ] wiped out Hojo clan in [ ] in [ ] and ruled all over Japan at last.

When the user's focus is on the first blank, for example, the system shows a multiple-choice list containing:
Nobunaga Oda,
Hideyoshi Toyotomi,
Shingen Takeda and
Kenshin Ueshugi
, because the blank's answer is Hideyoshi Toyotomi and this is a person's name.

It is easy for a user to use the sentences in a CD-ROM or in a website as data of the system which shows question sentences and multiple-choice lists.

However there are some demerits.

First, it is not clear for a user which word will be treated as blank question when he or she views question sentences. In order to solve this problem, one may use the emphasis display function of a text editor. Some text editor can display words the user specified emphatically. But, even if emphatically displaying words file is created automatically by the system, the user must specify which words file will be used respectively when using a text editor. These operations are cumbersome.

Second, when a term appears in many locations in the question sentences, the system cannot control to make the some of them be shown as blank questions. For example, when Hideyoshi Toyotomi was stored in the term list and there are ten same names in the question sentences, the system cannot treat only the 2nd, 4th and 7th Hideyoshi Toyotomi as blank question.

(d) a Learning System Using a Link

A ‘link’ is well-known art. It is an entry that points directly to some other information. If a system showing ‘fill-in-the-blanks’ questions and a multiple-choice list uses ‘links’, its data file is, for example, like follows.

@@question

[01 ] who succeeded Nobunaga Oda wiped out [02] clan in Odawara in [03] and ruled all over Japan at last.
   @@terms
01=Hideyoshi Toyotomi,Mituhide Aketi,Ieyasu Tokugawa
02=Hojo,Imagawa,Takeda,Fujiwara
03=1590,1582,1592,1600

The question sentence begins from the next line following ‘@@question’ to previous line before the ‘@@terms’. The numerals in the brackets in the question sentence are link entries.

The linked information begins from the next line following ‘@@terms’. It comprises a link entry, an equal symbol, a correct choice first and incorrect choices following delimited by comma.

The demerit of this system is that its data format is peculiar. In order to modify the original sentence ‘Hideyoshi Toyotomi who succeeded Nobunaga Oda wiped out Hojo clan in Odawara in 1590 and ruled all over Japan at last.’ into the data above, one must extract key words, add link entries, save the key words in another location with link entries and add incorrect choices. This is cumbersome and time-consuming. If a dedicated program is created and added to the system to help this editing, one may edit them a little easily, but, in this case, one must learn how to use the program.

If link entries are omitted and a multiple-choice list is described directly in the blank portion, the data file will be as follows.

[Hideyoshi Toyotomi,Mituhide Aketi,Ieyasu Tokugawa] who succeeded Nobunaga Oda wiped out [Hojo,Imagawa,Takeda,Fujiwara] clan in Odawara in [1590,1582,1592,1600] and ruled all over Japan at last.

In this case, it is yet cumbersome and time-consuming to add corresponding incorrect answer choices into the bracketed portion.

Moreover, this file format is so peculiar that one cannot use it on other systems and have difficulty in re-converting it into a plain text file.

Microsoft(™) put an operating system named Windows(™) 95 on the market in 1995 and various learning/testing systems were created from around 1996. However most of the systems disappeared on the market in two or three years.

The first reason is that it is difficult to create the data file. While advancing learning, one will need more data sooner or later. Then, if it is difficult to create data, the syetem will be no longer used.

The second reason is that the compatibility of data is low. Few learning systems regarded data compatibility as important. If the data format of a system is peculiar, it is difficult to convert it into the other system's data or convert to the contrary. When the system is no longer used, the system's data is also no longer used.

This is a great waste of data with a long-term view. Data for learning/testing should be accumulated and used again and again, and in order to realize this, data compatibility must be high.

For example, a hexadecimal format data is one of the worst compatible one. If data is saved as a text file, its compatibility is much higher than that of a hexadecimal file because text data can be edited on not only text editors but also word processors, spreadsheet programs, and database management systems. But, of course, if a text contains peculiar entry like the data using ‘links’ or its format is peculiar, its compatibility is low. The third reason is that it is difficult to understand the functions of a learning system. For example, the authoring tool ‘Director’(™) of Macromedia(™) U.S. has various functions such as not only displaying characters and static images but also displaying animation and playing sound. However it is so difficult to use the system that one must learn how to use it with a textbook.

A personal computer is not worth itself but only a tool to learn, and neither is a program. Because it is the most important for a user to lean knowledge, how to use the system/program or making data must not burden a user.

The fourth reason is that it is cumbersome for most users to operate a computer. For example, it is not easy for most users to input words with a keyboard even if the user can touch-type. Most of prior learning or testing systems require a user to input character string. The number of words a user can input with a keyboard is less than writing on a paper and the input operation burdens the user. So learning with personal computer was regarded as less effective than the conventional learning method with printed matter and something to write with.

In those days, it was considered natural to input words when using a computer. And few people recognized that the input operation is inefficient when leaning knowledge until the system described next in (e) was put on the market.

(e) U.S. Pat. No. 6,632,096 Japan Pat 3554742

The system of the disclosed method displays ‘fill-in-the-blanks’ questions. And it shows the answers in the blank boxes one by one when a user presses a predetermined key on a keyboard.

The learning system meets the requirements as follows:
(1) Easy for a user to create the data file
(2) Data compatibility is high
(3) Easy for a user to understand the system's function
(4) Easy for a user to operate a computer when using the learning system

According to the disclosed method, a data file for the system is a text file with key words bracketed by predetermined character such as ‘[’ and ‘]’.

When a user convert a ordinary text ‘Hideyoshi Toyotomi who succeeded Nobunaga Oda wiped out Hojo clan in Odawara in 1590 and ruled all over Japan at last.’ into the data of this system, he or she must only insert ‘[’ in front of and ‘]’ behind the key words as follows;
[Hideyoshi Toyotomi] who succeeded Nobunaga Oda wiped out [Hojo] clan in Odawara in [1590] and ruled all over Japan at last.

This is the easiest way to create a data for ‘fill-in-the-blanks’ question. When re-converting the data into a plain text, one can easily remove ‘[’ and ‘]’ by using replacing function of a text editor. These symbols disappear when they are replaced by null string.

It is clear for a user which words are showed as blank question, so it is easy to edit the data file.

A user must only press a predetermined key on the keyboard such as Return key when learning with the system. This is the easiest operation. It is so easy that the user can ascertain a lot of knowledge in a short time. A skilled learner would be able to answer orally 1,000 blank questions in 40 minutes. The user cannot able to answer so many questions quickly if he or she uses other learning system or printed matter.

The worth of this invention is, first, the combination of the easiest way to create a data file and the easiest operation of a computer, and second, the control method of process which allows a user only to press a predetermined key on the keyboard when learning. Usually one use a keyboard to input many characters, but in case of this system, one use a keyboard to press a single key.

The program of this invention is actually put on the market on the Internet and the number of the users still continues increasing. The data files for this program's system are being sold on the Internet. Some students got brilliant results in term exams at school, and others passed qualifying examinations.

It is true this system is very useful to learn knowledge but it does not provide a testing function. It does not examine whether the user's knowledge are correct or not.

(f) Japan Patent 3321650 ‘a Leaning system’

The disclosed system displays sentences with key words replaced to blanks and the corresponding multiple-choice list just below each blank. A user select one choice and the system examines whether the user-selected choice is correct or not and shows the result. It reads the same data file as that of (e). Each multiple-choice list contains the key word omitted in the question sentence as a correct answer and other key words corresponding to other blanks as incorrect answers.

This system meets the requirements as follows:

(1) Easy for a user to create the data file in a meaning
(2) Data compatibility is high
(3) Easy for a user to understand the system's function
(4) Relatively easy for a user to operate a computer when using the system
(5) The system examines user's knowledge

However, it has a demerit. For example, in a history text file, there are various kinds of terms such as person's names, place names, year numbers, event names and so on. When creating the data file for this system, one must bracket a single kind of key words such as person's names only.

One can easily know what kind of term will come in each blank through the context. If all kinds of terms are bracketed, for example, a place name may be in the multiple-choice list corresponding to the person's name blank.

So, when creating history data files, one must create, for example,
a data file with only person's names bracketed,
a data file with only place names bracketed,
a data file with only year numbers bracketed, and
a data file with only event names bracketed.

It is true that it is easy in a meaning for a user to bracket key words in order to create data files, but it is cumbersome in another meaning that the user must bracket a single kind of terms and create the same number of data files as that of kinds of terms.

### BACKGROUND OF THE INVENTION—OBJECTS AND ADVANTAGES

(a) It is therefore an object of the present invention to provide a method and system for testing knowledge by key word methodology using a computer which enables a user easily create a data files of question sentences and multiple-choice lists of terms.

(b) Another object of the present invention is to use the file format of (e) and (f) just as it is. If the file format is altered, the data files for the system of (e) and (f) cannot be used as it is.

(c) In order to create a system that attain above objects, the following data files are used. These data are for a biology test of Japan National Center for University Entrance Exam. The file names, file sizes, line counts and the numbers of blank questions of the text files are as follows.

folder name = center test biology
file count = 36

| Text | File name | Size | Line | Blank |
|---|---|---|---|---|
| 1_1 | Intracellular Structure | 3761 | 104 | 60 |
| 1_2 | Cell and osmotic-pressure | 749 | 23 | 7 |
| 2_1 | Vegetation organization | 2260 | 74 | 27 |
| 2_2 | Animal organization | 597 | 22 | 11 |
| 3_1 | Meiosis | 1151 | 45 | 16 |
| 3_2 | Moss and fern | 1337 | 45 | 23 |
| 3_3 | Reproduction of angiosperm | 1081 | 36 | 19 |
| 3_4 | Various reproduction | 1136 | 39 | 12 |
| 4_1 | Animal ontogeny | 3484 | 95 | 57 |
| 4_2 | Animal ontogeny and | 1717 | 58 | 29 |
| | specialization | | | |
| 5_1 | Body of gene | 1780 | 50 | 9 |
| 5_2 | Lows of heredity | 4365 | 151 | 45 |
| 5_3 | Linkage and recombination | 3664 | 116 | 36 |
| 5_4 | Recombination rate | 1397 | 50 | 15 |
| 5_5 | Gene collaboration | 2995 | 108 | 31 |
| 5_6 | Sex chromosome | 1950 | 56 | 25 |
| 5_7 | Variation and mutation | 1543 | 47 | 13 |
| 6_1 | Metabolism and biological | 3144 | 99 | 43 |
| | substance | | | |
| 6_2 | Enzyme | 2446 | 67 | 33 |
| 6_3 | Respiration | 2967 | 80 | 42 |
| 6_4 | Photosynthesis and | 908 | 30 | 17 |
| | chemosynthetic-bacteria | | | |
| 7_1 | Blood | 4484 | 135 | 48 |
| 7_2 | Excretion | 2469 | 55 | 26 |
| 7_3 | Hormone | 7576 | 232 | 158 |
| 7_4 | Control of osmotic pressure | 2452 | 70 | 28 |
| 7_5 | Hormone of crustacean and insect | 1670 | 51 | 29 |
| 7_6 | Control in vegetation | 2657 | 83 | 26 |
| 7_7 | Environmental factor and | 1090 | 34 | 5 |
| | living things | | | |
| 7_8 | Nerve | 1977 | 65 | 32 |
| 8_1 | Ecosystem | 2980 | 94 | 40 |
| 8_2 | Life-form of vegetation | 826 | 26 | 3 |
| 8_3 | Classification of population | 1329 | 45 | 6 |
| 8_4 | Action of animal | 1561 | 45 | 20 |
| 8_5 | Relation within a kind and | 1518 | 42 | 16 |
| | between kinds | | | |
| 8_6 | Insect communication | 1205 | 39 | 11 |
| 8_7 | Environmental pollution | 1149 | 34 | 6 |

| | | | | |
|---|---|---|---|---|
| Sum Total | 79375 | byte | 2445 | 1024 |

When creating a data file, for example, for Gotaku, one must write four incorrect choices responding to each correct answer. One must write 4,096 incorrect choices when there are 1,024 correct answers like above.

Because it is a burden to write such many data, a still further object of the present invention is to provide a method and system that enables a user to create choice file with as little effort as possible.

Gotaku is known as a quiz program rather than as a learning one. It shows in a window a question sentence that does not exceed 116 byte and five choices one of which is a correct answer and others incorrect answers. It shows questions at random using random number. Its data comprises fragmentary information, and the answers of the questions are rarely the same as nor related to one another.

However, if a lot of texts in a field are created and more than 1,000 words were determined as blank question as above, the answer of one blank questions is often the same as or a near-synonym of that of another blank question.

For example, answers of the 12 blank questions in above texts are in the list as follows;
Na,K,Ca,Mg,Fe,Cu.

In above case, the majority of the answers of blank questions turned out to be the same as or a near-synonym of that of another blank question. This means that the file of sets of terms can be often shared. A shared choice file enables a user to reduce the burden to write terms.

However, it turned out that, if this shared choice file is the only file to store terms for multiple-choice lists, it is sometimes inconvenient. The example is explained as follows.

Suppose that there are two text files as below.
vegetable hormone.txt
[Indoleacetic acid] is synthesized near the growing point of a bud, and makes cells elongate.
[Gibberellin] makes cells elongate and makes a seed sprout.
[Abscisic acid] prevents a seed from sprouting and closes pores in a short time.
[Ethylene] ripens fruits.

environmental pollution.txt

If the [chlorofluorocarbon] gas being used in the air-conditioner or the refrigerator as a refrigerant is released into the air, it will destroy the ozone layer high up in the sky.

The [carbon dioxide] emitted by mass consumption of a fossil fuel causes the greenhouse effect.

There are four key words in the former text file. One must only create a shared choice file as follows.

shared choice terms.CSV
vegetable hormone,abscisic acid
vegetable hormone,indoleacetic acid
vegetable hormone,gibberellin
vegetable hormone,kinetin
vegetable hormone,ethylene

This is a CSV file whose line comprises a group name, a comma, and a shared choice term belonging to the group.

The system should show the list that contains
abscisic acid,
indoleacetic acid,
gibberellin,
kinetin, and
ethylene
as a multiple-choice list for the blank question whose correct answer is abscisic acid, indoleacetic acid, gibberellin, kinetin, or ethylene in the vegetable hormone.txt.

This list is appropriate as a multiple-choice list and because one must only write a single list of terms with the group name of vegitable hormone as above, one don't have to store four incorrect choice terms to each correct choice respectively.

On the other hand, gas names such as ‘methane, ethane, ethylene, acethylene’ are appropriate as incorrect choice terms to a blank question whose correct answer is chlorofluorocarbon in environmental pollution.txt. These incorrect choice terms are appropriate only when chlorofluorocarbon is the correct answer and they can not be shared by one another. The same is the case with ‘carbon dioxide’ in environmental pollution.txt.

A dedicated list of choice terms should be created to ‘chlorofluorocarbon’ and ‘carbon dioxide’ in environmental pollution.txt.

A file named ‘environmental pollution.trm’ is stored. This file has the same file name with a different extension ‘trm’. Its contents are;

environmental pollution.trm
chlorofluorocarbon,methane,ethane,ethylene,acethylene
carbon dioxide,methane,sulfer dioxide,nitrogen oxides

A line in this file comprises a correct choice first and corresponding incorrect choices following delimited by comma.

Thus, it is necessary to store two kinds of choice file, one is ‘a shared choice file’ which comprises group name and shared choice terms, and another is ‘a corresponding choice file’ which comprises incorrect choice terms corresponding to specific terms of a specific file.

The fourth object of the present invention is to provide a method and system that reads these two kinds of choice files.

(d) There are cases where a key word belongs to both kinds of files. In this case, it turned out that the choices in the ‘corresponding choice file’ should be given priority in creating a multiple-choice list, because one can set up incorrect choices as one wants to. The fifth object of the present invention is to provide a method and system which reads and searches ‘a corresponding choice file’ first and ‘a shared choice file’ next.

### SUMMARY

The invention, therefore, includes a method of creating a computer-based testing system which shows sentences with some words replaced to blanks, shows a multiple-choice list for each blank, and let the user select a correct choice, said method comprising:
reading from a storage unit a file of sentences with some of key words being bracketed by predetermined characters and shows the sentences with said bracketed words replaced to blanks;
searching said bracketed words in the corresponding choice file linked to said sentence file;
if said bracketed words is found in said search, creating a multiple-choice list for each blank in said sentences by referring to the corresponding terms in said corresponding choice file;
if said bracketed words is not found in said search, searching said bracketed words in shared choice files in which near-synonyms are listed in groups; and
if said bracketed words is found in said shared choice files, creating a multiple-choice list for each blank in said sentences by referring to the near-synonyms in the same group in said shared choice files.

Because this system creates a multiple-choice list from the choice file other than the text file of question sentences, one don't have to specify the same kinds of words.

The question text file is the same as that of (e) and (f). The system of (e) and (f) has a compatibility with this system in data file.

Because a shared choice file is shared by any question text files, when there are the same key words or near-synonyms in the question text files, one can create choice terms files efficiently.

Because the corresponding choice file is read first and the correct choice words are searched first in this file to create a multiple-choice list, one can set up the incorrect choices as one wants to.

### DRAWINGS—FIGURES

FIG. 1 is a flow chart of the process performed by the present system;

FIG. 2 is a “screen shot” of a window on a display device of the present system showing the question sentences in the question text file with bracketed portions replaced to blanks;

FIG. 3 is a “screen shot” of the window on the display device of the present system showing the question sentence in the question text file with rectangle blanks;

FIG. 4 is a “screen shot” of the window on the display device of the present system showing the multiple-choice list when a user points the first blank with a pointing device;

FIG. 5 is a “screen shot” of the window on the display device of the present system showing the answer the user selected in the first blanks; and

FIG. 6 is a block diagram of devices according to the present invention.

### DRAWINGS—REFERENCE NUMERALS

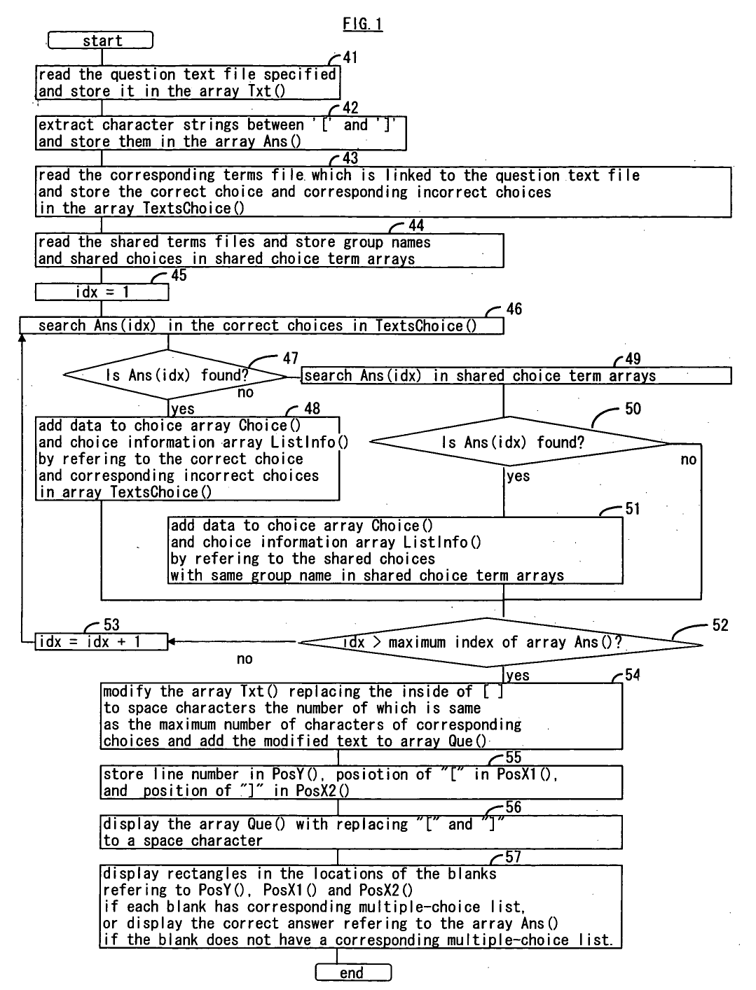

FIG. 1
41-57 process

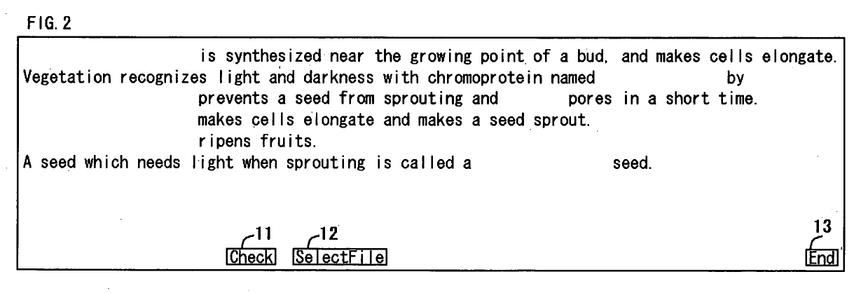

FIGS. 2,3, and 4
11 command button
12 command button
13 command button
14 rectangle blank
15 multiple-choice list

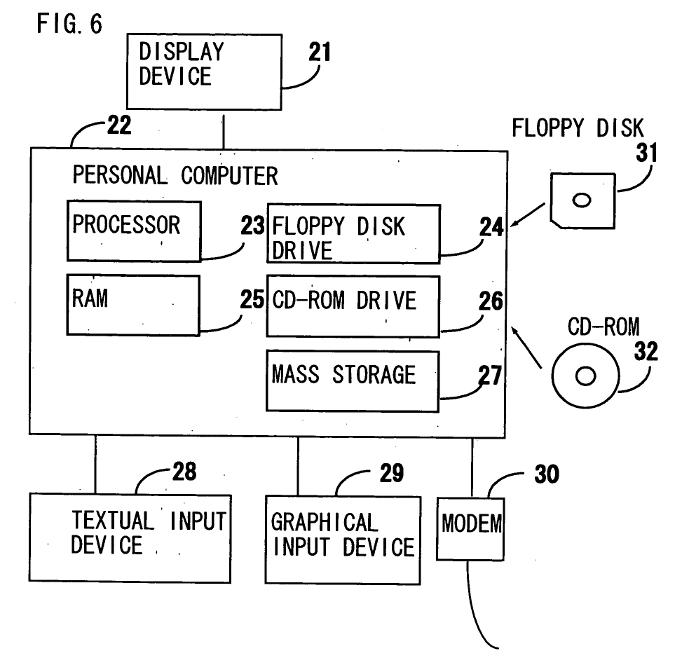

FIG. 6
21 display device
22 personal computer
23 processor
24 froppy disk drive
25 random access memory
26 CD-ROM drive
27 mass storage
28 textual input device
29 graphical input device
30 modem
31 floppy disk
32 CD-ROM

### DETAILED DESCRIPTION—FIG. 6—PREFERRED EMBODIMENT

Reference is now made to FIG. 6 wherein there is shown a block diagram of a learning system of the present invention. The system includes a personal computer 22, a textual input device 28, a graphical input device 29, a display device 21 and a modem 30. The means for interconnecting the computer 22 to the various components shown in FIG. 6 is well known in the art.

The personal computer 22 can be a personal computer having a microprocessor 23, such as an Intel Pentium (tm) or similar, at least 32 MB random access memory (RAM) 25, mass storage (hard disk drive) 27, a floppy disc drive 24 and a CD-ROM drive 26. It will, of course, be understood that any computing system having equivalent functional and operational capabilities may be substituted for the personal computer 22. The floppy disc drive 24 allows the computer 22 to receive and access a floppy disk 31 containing program data and user data. Such data is accessed directly from the floppy disc 31 and/or stored by the computer in, and accessed from RAM 25 and/or mass storage (hard disk drive) 27 as necessary.

The display device 21 preferably comprises an SVGA monitor for providing a display of high quality images.

The textual input device 28 can be, for example, a standard QWERTY-type alphanumeric keyboard, with function keys, through which the system user may both input alphanumeric text for processing and/or display by the computer 22 and select certain functions and operations for computer execution. The graphical input device 29 can be either a joystick, mouse, trackball, or other pointing device as desired, to provide the computer user with a pointing and selecting device for on-screen selection of options and features in a well known manner (commonly referred to in the art as a “point-and-click” operation). It will, of course, be understood that other types of input devices may be used. For example, the display device 21 may further include a touch screen capability. In addition, an audio system may be used for audible input with the addition of speech recognition functionality to the processor 23.

The processor 23 controls operation of the present system, including controlling all communications by and between the personal computer 22 and the textual input device 28, the graphical input device 29, the display device 21 and the modem 30. The personal computer 22 operates according to a system operation program downloaded from either the CD-ROM 32 or the mass storage (hard disk drive) 27 to the RAM 25. The user of the system controls the functioning and execution of the system operation program, and therefore the operation of the system, by providing commands input via the textual and graphical inputs 28 and 29, respectively.

### DETAILED DESCRIPTION—FIG. 1—PREFERRED EMBODIMENT

Reference is now made to FIG. 1 wherein there is shown a flow chart of a testing system of the present invention when a user start the system and select a question text file until the system shows the initial window.

Below is the example of the question text file that is selected by a user.

vegetable hormone.txt
[Indoleacetic acid] is synthesized near the growing point of a bud, and makes cells elongate.
Vegetation recognizes light and darkness with chromoprotein named [phytochrome] by [leaves].
[Abscisic acid] prevents a seed from sprouting and [closes] pores in a short time.
[Gibberellin] makes cells elongate and makes a seed sprout.
[Ethylene] ripens fruits.
A seed that needs light when sprouting is called a [photoblastic] seed.

Below is the example of a corresponding choice file. This file is stored in the same folder of or the subfolder of that of the question text file.

vegetable hormone.trm
leaves,buds,stems
phytochrome,chlorophyll,carotene,xanthophyll

Below are the examples of shared choice files.

technical choice terms.CSV
vegetable hormone,abscisic acid
vegetable hormone,indoleacetic acid
vegetable hormone,gibberellin
vegetable hormone,kinetin
vegetable hormone,ethylene
animal digestive enzyme,amylase
animal digestive enzyme,maltase
animal digestive enzyme,pepsin
animal digestive enzyme,trypsin

general choice terms.CSV
true,false
correct, incorrect
large,small
opens,closes
east,west,south,north

A line of ‘technical choice terms.CSV’ comprises a group name and a term. Near-synonyms with same group name form a multiple-choice list. The terms in the same group are the mutual choices. This file is stored in the same folder of or in the subfolder of the question text file.

A line of ‘general choice terms.CSV’ comprises a list of terms without a group name. The terms in a line are the mutual choices. This file is stored in the same folder including the program of the present system.

The predetermined characters that specify the key words/terms for blank questions are ‘[’ and ‘]’. Referring FIG. 1, at step 41, the question text file is read and question sentences are stored into an array Txt( ) as follows:
Txt(1)=”[Indoleacetic acid] is synthesized near the growing point of a bud, and makes cells elongate.”
Txt(2)=“Vegetation recognizes light and darkness with chromoprotein named [phytochrome] by [leaves].”
Txt(3)=”[Abscisic acid] prevents a seed from sprouting and [closes] pores in a short time.”
Txt(4)=”[Gibberellin] makes cells elongate and makes a seed sprout.”
Txt(5)=”[Ethylene] ripens fruits.”
Txt(6)=“A seed which needs light when sprouting is called a [photoblastic] seed.”

At step 42, the system extracts the character strings between ‘[’ and ‘]’ and store them in answer array Anso. In order to create Anso, the system searches for ‘[’ first. If found, it searches ‘]’ from the position next to ‘[’. When both of ‘[’ and ‘]’ found, it stores the character string between ‘[’ and ‘]’ with the first character converted lower-case in Ans( ). It results in as follows:
Ans(1)=“indoleacetic acid”
Ans(2)=“phytochrome”
Ans(3)=“leaves”
Ans(4)=“abscisic acid”
Ans(5)=“closes”
Ans(6)=“gibberellin”
Ans(7)=“ethylene”
Ans(8)=“photoblastic”

At step 43, the system reads the corresponding choice file. Because ‘vegetable hormone.trm’ has the same file name as that of the question text file ‘vegetable hormone.txt’ with an extension ‘trm’, the system reads this file as the corresponding choice file and stores choice data in a array TextsChoice( ).

The element of TextsChoice( ) comprises a structure as shown in the following example.

Public Type ChoiceType
Choice As String ‘choice words
LineN As Integer ‘line Number

End Type

After the system reads the data, this array has information as follows:
TextsChoice(1).Choice=“leaves”
TextsChoice(1).LineN =1
TextsChoice(2).Choice=“buds”
TextsChoice(2).LineN=1
TextsChoice(3).Choice=“stems”
TextsChoice(3).LineN=1
TextsChoice(4).Choice=“phytochrome”
TextsChoice(4).LineN=2
TextsChoice(5).Choice=“chlorophyll”
TextsChoice(5).LineN=2
TextsChoice(6).Choice=“carotene”
TextsChoice(6).LineN=2
TextsChoice(7).Choice=“xanthophyll”
TextsChoice(7).LineN=2

In this array, the Choice's value of the arrays whose index is the minimum in the elements with the same line number is the correct choice and others are incorrect choices.

Next, at step 44, the system reads the shared choice files ‘technical choice terms.CSV’ and ‘general choice terms.CSV’. The data read from these files are stored into TechChoice( ) and GeneralChoice( ) respectively, and their structure is like below.

Public Type Choice2Type
Choice As String ‘choice
Group As String ‘group name

End Type.

After the system reads the data, the arrays have information as follows:
TechChoice(1).Choice=“abscisic acid”
TechChoice(1).Group=“vegetable hormone”
TechChoice(2).Choice=“indoleacetic acid”
TechChoice(2).Group=” vegetable hormone”
TechChoice(3).Choice=“gibberellin”
TechChoice(3).Group=“vegitable hormone”
TechChoice(4).Choice=“kinetin”
TechChoice(4).Group=“vegetable hormone”
TechChoice(5).Choice=“ethylene”
TechChoice(5).Group=“vegetable hormone”
TechChoice(6).Choice=“amylase”
TechChoice(6).Group=“animal digestive enzyme”
TechChoice(7).Choice=“maltase”
TechChoice(7).Group=“animal digestive enzyme”
TechChoice(8).Choice=“pepsin”
TechChoice(8).Group=“an animal digestive enzyme”
TechChoice(9).Choice=“trypsin”
TechChoice(9).Group=“animal digestive enzyme”
GeneralChoice(1).Choice=“true”
GeneralChoice(1).Group=“1”
GeneralChoice(2).Choice=“false”
GeneralChoice(2).Group=“1”
GeneralChoice(3).Choice=“correct”
GeneralChoice(3).Group=“2”
GeneralChoice(4).Choice=“incorrect
GeneralChoice(4).Group=“2”
GeneralChoice(5).Choice=“large”
GeneralChoice(5).Group=“3”
GeneralChoice(6).Choice=“small”
GeneralChoice(6).Group=“3”
GeneralChoice(7).Choice=“opens”
GeneralChoice(7).Group=“4”
GeneralChoice(8).Choice=“closes”
GeneralChoice(8).Group=“4”
GeneralChoice(9).Choice=“east”
GeneralChoice(9).Group=“5”
GeneralChoice(10).Choice=“west”
GeneralChoice(10).Group=“5”
GeneralChoice(11).Choice=“south”
GeneralChoice(11).Group=“5”
GeneralChoice(12).Choice=“north”
GeneralChoice(12).Group=“5”

As there are no group name in ‘general choice terms.CSV’, the system stores a line number for a group name in GeneralChoice( ).Group.

Next, the system creates multiple-choice lists corresponding to each element of Ans( ) through the steps that begin at step 45 and loops from step 46 to step 52 and 53.

A more detailed example of a process in which the program performs is as follows.

The system searches Ans(1) “indoleacetic acid” in TextsChoice( ).Choice, but it can not find, so the process flows to step 49. As it find “indoleacetic acid” in TechChoice( ).Choice, the system creates a multiple-choice list containing abscisic acid,indoleacetic acid,gibberellin,kinetin, and ethylene, which have the same group name in TechChoice( ).Group.

At step 51, the system stores these correct and incorrect choices to Choice( ) in random order by generating random number, and at the same time, it stores in ListInfo( ) the first, the last index corresponding to Ans(1) and the correct choice's index.

The structure of Listlnfo( ) is like follows.

Public Type ListInfoType
FromIdx As Integer ‘first index for Ans(i)
ToIdx As Integer ‘last index for Ans(i)
RightIdx As Byte ‘correct choice's index

End Type

The example of Choice( ) is as follows:
Choice(1)=“gibberellin”
Choice(2)=“indoleacetic acid”
Choice(3)=“ethylene”
Choice(4)=“abscisic acid”
Choice(5)=“kinetin”

In above case, Listlnfo(1) is as follows.
ListInfo(1).FromIdx=1
ListInfo(1).ToIdx=5
ListInfo(1).RightIdx=2

This means that choices corresponding to the 1st blank were stored in the array Choice( ) whose indexes are from 1 to 5 and the 2nd choice is the correct answer.

For Ans(2) “leaves”, the system finds it in TextsChoice( ).Choice and the index is minimum in the array element with the same LineN, so the system flows to step 48.

The examples of Choice( ) and ListInfo(2) are follows:
Choice(6)=“buds”
Choice(7)=“stems”
Choice(8)=“leaves”
ListInfo(2).Fromldx=6
ListInfo(2).ToIdx=8
ListInfo(2).RightIdx=3

By repeating the process from step 46 to step 52 or 53, the arrays Choice( ) and ListInfo( ) are completed.

As with Ans(8) “photoblastic”, there is not corresponding choices, so no value is not added to Choice( ) and ListInfo(8) becomes like follows.
ListInfo(8).FromIdx=0
ListInfo(8).ToIdx=0
ListInfo(8).RightIdx=0

Next, at step 54, the system makes array Que( ) by replacing the inside between “[” and “]” of the sentences in Txt( ) to space characters with its number the same as the maximum byte of corresponding choices.

For example, as with Ans(7) “ethylene”, the corresponding choices are:
abscisic acid,indoleacetic acid,gibberellin,kinetin,ethylene
and the maximum byte of these choices is 17 byte of “indoleacetic acid”,
so “Ethylen” in
Txt(5)=”[Ethylene] ripens fruits.”
was replaced to 17 space characters, and Que(5) results in below.
Que(5)=“[ ] ripens fruits.”

(There are 17 space characters between “[” and “]” in above sentence.)

The reason to modify the text as above is that one can not guess the correct choice by the hint of the width of a blank and that the system should be able to display the longest choice.

The array Queo is created as follows:
Que(1)=“[ ] is synthesized near the growing point of a bud, and makes cells elongate.”
Que(2)=“Vegetation recognizes light and darkness with chromoprotein named [ ] by [ ].”
Que(3)=“[ ] prevents a seed from sprouting and [ ] pores in a short time.”
Que(4)=“[ ] makes cells elongate and makes a seed sprout.”
Que(5)=“[ ] ripens fruits.”
Que(6)=“A seed which needs light when sprouting is called a [ ] seed.”

There are 17,11,6,17,6,17,17 and 12 space characters in each bracketed blank respectively.

Next, at step 55, the system stores line number in a array PosY( ), position of “[” in a array PosX1( ), and position of “]” in a array PosX2( ).

For example, as with the 1st blank, it is in the 1st line, “[” is in the 1st byte and “]” the 19th byte, so it result in PosY(1)=1, PosX1(1)=1 and PosX2(1)=19.

Next, at step 56, the system shows Queo onscreen with replacing “[” and “]” to a space character. FIG. 2 is the example of the screen showed after step 56.

Next, at step 57, if there is a corresponding multiple-choice list to each blank, a rectangle is shown in each location referring to PosY( ), PosX1( ) and PosX2( ). If there is not a corresponding multiple-choice list to a blank, the correct answer is shown with an underline.

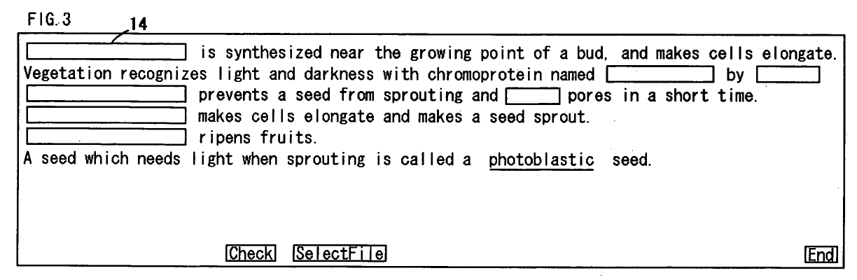

FIG. 3 is the example window shown after step 57 and this is the initial window of this system.

By the way, although the data structure and inside processing of the system are described in detail in this specification, there are various ways to deal with data and processing.

Alternative Embodiments

As with data, there are various structure such as:
multiple-choice lists with or without group name;
choices(choice groups) delimited by comma, tab, line feed character; and
a text file or a hexadecimal file.

Even with processing, there are various way in using variables, arrays, and structures.

However, even if there are differences in data structure or processing and there are some merits or demerits, they are the same system in design if it performs the same processing described in the claims and there are no remarkable differences in effect.

Because designing a system program is quite different from coding it, the difficulty in design differs from that in coding. The present invention relates to designing processes.

The processing after showing the initial window is like follows.

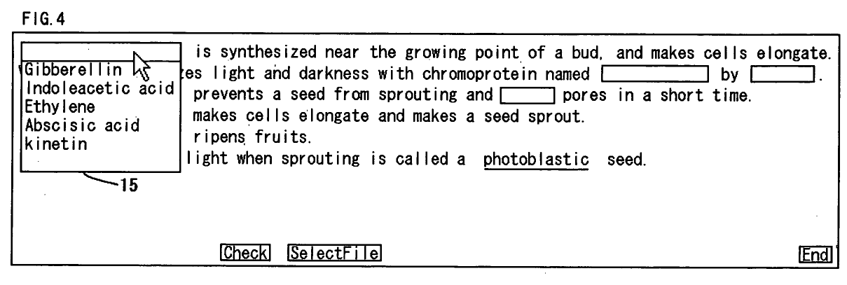

When a user moves a mouse pointer on a blank, the system shows the corresponding multiple-choice list just below the blank and let the user select one choice. (FIG. 4)

The first characters of the choices are converted upper-case if necessary.

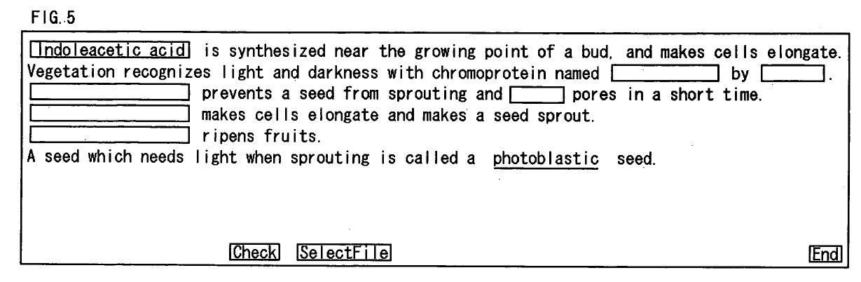

The system shows the user-selected choice in the blank. (FIG. 5)

The system checks when the user finishes selecting and clicks the command button 11.

Although there are various processing after the initial window, they are not the essence of the present invention.

The essences of the present invention are as follows:

Designing a system program the way to read two kind of choice file which are independent from a question sentence file, one is a corresponding choice file which is linked to the question sentence file and contains key words in the question sentence file (correct choices) and corresponding incorrect choices, and another is shared choice files containing near-synonyms (mutual choices).

Designing a system program the way to search terms in the corresponding choice file prior to shared choice files when creating multiple-choice lists.

Advantages

By designing a system program as above, all the objects described in this specification are attained. When creating choice files, if there are many same words or near-synonyms in the question sentence file, the burden to write terms is reduced greatly.

There are 1,024 blank question in the 36 text files for biology test of Japan National Center for University Entrance Exam and 700 blanks of them becomes multiple-choice questions by using shared choice files.

The numbers of groups and terms in shared choice files are as follows:

| file name | group | term |
|---|---|---|
| technical choice terms.CSV | 110 | 342 |
| general choice terms.CSV | 52 | 131 |
| sum total | 162 | 473 |

As you see, the total number of terms for 700 multiple-choice questions is only 473. In case of Gotaku, one must write 3,500 words in a data file for 700 multiple-choice questions. Though, of course, all the multiple-choice lists in the present system contains five choices, the present invention allows a person to reduce the burden to write terms in choice files. This is one of the remarkable effects of this method/system.

Not only in biology but also in other field, there are many cases in which same words or near-synonyms are included in a text file, so the present method/system often allows a person to write terms in choice files with the minimum effort.

There are cases where it is difficult to write choice terms in a shared choice file.

In such case, one can write it in a corresponding choice file. This file can not be shared but is useful when controlling the choices as one wants to.

Compared with the system of (c) Japan Patent Application Heisei 4-268049 ‘a leaning support machine’ being altered into a testing system showing a multiple-choice question, there are some merits in the present system.

In case of the present system, it is clear which words in the question sentence are showed as blank question. However, in case of (c), it is not clear which words in the question sentence are showed as blank question when viewing only the question text file and one cannot specify some of the same words to be displayed as blank questions.

Next, in the claims of (c), there are not described from where the system read the dictionary data. In the specification, there is an example that the dictionary data is stored in ROM. When the dictionary data is stored in ROM, one cannot add data. Further, in order to read ROM data, a dedicated device is necessary, so it is difficult to share the ROM.

In case of the present system, because choice files are ordinary files, one can add data to it, copy it and share it. These are clearly more effective.

Further, in case of the present system, the two kinds of choice files ‘shared choice files’ and ‘a corresponding choice file’ allow the creator of the choice file to easily control the multiple-choice list to each blank question.

Further, in case of the present system, because the data format of a question sentence file is the same as that of (e) and (f), one can use the question file more effectively.

Further, in case of the present system, because the shared choice files are shared among question files, the creator of the shared choice files can sell these files only.

For example, when one publishing company creates:
30 question text files for biology,
30 corresponding choice files,
one general choice file, and
one technical choice file,
and another publishing company creates a number of question text files for biology, the general choice file and the technical choice file can be shared, so the former company can sell these files to the latter one.

### CONCLUSION, AND SCOPE

The effects and advantages discussed above allow a person to easily create data files for education and learning and easily operate a computer when learning, so the data will be used again and again and enables students to learn a lot of knowledge easily.

It is understood, of course, that while the forms of the system herein shown and described include the best mode contemplated for carrying out the present system, they are not intended to illustrate all possible forms thereof.

It will also be understood that the scope of the invention should be determined by the appended claims and their legal equivalents, rather than by the example given.

1. A method of creating a computer-based testing system that shows sentences with words replaced by blanks, shows a multiple-choice list for said blanks, and lets a user select a correct choice from said list, said method comprising:
reading, from a storage unit, a sentence file having a sentence with bracketed words being bracketed by predetermined characters and showing the sentence with said bracketed words replaced by blanks;
searching said bracketed words in a corresponding choice file linked to said sentence file;
if said bracketed words are found in said corresponding choice file, creating a multiple-choice list for a blank of said blanks in said sentence by referring to corresponding terms in said corresponding choice file;
if said bracketed words are not found in said corresponding choice file, searching said bracketed words in shared choice files having near-synonyms, said near-synonyms being listed in groups; and
if said bracketed words are found in said shared choice files, creating a multiple-choice list for said blank by referring to the near-synonyms in a same group of said shared choice files.

2. The method of claim 1, further comprising reading said shared choice files from said folder.

3. The method of claim 1, wherein said searching comprises extracting said bracketed words from said sentence file.

4. The method of claim 1, further comprising displaying said sentence file to a user.

5. The method of claim 1, further comprising displaying said multiple choice list to a user.

6. The method of claim 5, wherein said displaying comprises displaying said multiple choice list according to an indication by said user.

7. The method of claim 1, further comprising reading an answer array to create said multiple choice list.

8. The method of claim 7, further comprising filling said answer array with at least one element from said corresponding choice file or shared choice file.

9. The method of claim 1, further comprising generating a random order for said multiple choice list.

10. A computer-based testing system that shows sentences with words replaced by blanks, shows a multiple-choice list for each blank, and lets the user select a correct choice from said list, said system comprising:
reading means for reading, from a storage unit, a sentence file having a sentence with words being bracketed by predetermined characters and showing the sentence with said bracketed words replaced by blanks;
first searching means for searching said bracketed words in a corresponding choice file linked to said sentence file;
first creating means for creating a multiple-choice list for a blank in said sentence by referring to corresponding terms in said corresponding choice file for said bracketed words found in said corresponding choice file;
second searching means for searching said bracketed words in shared choice files having near-synonyms that are listed in groups if said bracketed words are not found in said corresponding choice file; and
second creating means creating the multiple-choice list for said blank in said sentence by referring to the near-synonyms in a same group in said shared choice files if said bracketed words are found in said shared choice files.

11. The system of claim 10, wherein reading means reads said shared choice file from said folder.

12. The system of claim 10, further comprising display means for displaying said sentence file.

13. The system of claim 10, further comprising input receiving means for receiving input from a user in response to said multiple choice list.

14. The system of claim 10, wherein said storage unit is to store said corresponding choice file or said shared choice file.

15. A method for creating a sentence having blanks to display on a computer-based testing system, said method comprising:
reading a sentence file from a folder, wherein said sentence file includes a sentence having words and wherein at least one word is replaced by a blank;
generating a multiple choice list for said blank by reading an answer array, wherein said answer array includes elements from a corresponding choice file or a shared choice file; and
randomly ordering said multiple choice list to display when selected by a user.

16. A computer-based testing system, comprising:
a reader to read a sentence file having a sentence with bracketed words being bracketed by predetermined characters from a storage unit and showing the sentence with said bracketed words replaced by blanks;
a data searcher to search said bracketed words in a corresponding choice file linked to said sentence file; and
a generator to generate a multiple-choice list for a blank in said sentence by referring to corresponding terms in said corresponding choice file if said bracketed words are found in said corresponding choice file,
wherein said data searcher searches said bracketed words in shared choice files having near-synonyms that are listed in groups if said bracketed words are not found in said corresponding choice file, and
wherein said generator generates the multiple-choice list for said blank in said sentence by referring to the near-synonyms in a same group of said shared choice files if said bracketed words are found in said shared choice files.
